(19) United States
(12) Patent Application Publication
(10) Pub. No.: US 2003/0120810 A1
(43) Pub. Date: Jun. 26, 2003

(54) Interconnecting device, address conversion controlling method and computer program thereof

(76) Inventor: Takayuki Ohta, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 10/063,247

(22) Filed: Apr. 3, 2002

(30) Foreign Application Priority Data
Dec. 26, 2001 (JP) 2001-395250

(51) Int. Cl. G06F 15/16

(52) U.S. Cl. 709/245

(57) ABSTRACT

An interconnecting device that interconnects communication between communication devices. A source address of a packet received from a first communication device is converted from an address of the first communication device to an address managed by the interconnecting device. The addresses are registered to correspond to each other. A processing unit determines whether or not a session between the communication devices has finished by transmitting a check packet, for confirming a communication status between the communication devices, to at least one of the communication devices. A release unit deletes the corresponding registration of the addresses in a memory unit, in a case where it is determined that the session between the communication devices has finished, so as to release the address managed by the interconnecting device. The interconnecting device of the present invention prevents unexpected disruption of a communication session between communication devices and provides efficient management of network address resources.

### CROSS REFERENCE TO RELATED APPLICATIONS

This patent application claims priority from a Japanese patent application No. 2001-395250 filed on Dec. 26, 2001, the contents of which are incorporated herein by reference.

### BACKGROUND OF INVENTION

1. Field of the Invention

The present invention relates to an interconnecting device, an address conversion controlling method and a computer program thereof stored in a computer-readable medium. More particularly, the present invention relates to an interconnecting device having Network Address Translation (NAT) functionality, which avoids disruption of communication between interconnected communication devices and provides efficient utilization of network address resources.

2. Description of the Related Art

A router having NAT functionality assigns a global IP address to a private IP address of a client PC of a LAN, converts a source IP address of a packet received from the client PC from the private IP address to the global IP address, and then transmits the packet having the converted address. In this way, the client PC can access a server on the Internet.

The conventional router having a NAT function determines, based on the presence or absence of the packet transmitted between the client PC and the server, whether or not a communication session between the client PC and the server continues. When a predetermined time has passed after the client PC and the server stopped the transmission of the packet, the router determines that the session between the client PC and the server finished, and cancels the assignment of the global IP address to the client PC.

In a case where there is no packet transmission between the client PC and the server, however, the client PC and the server are often in a waiting state while the session between the client PC and the server is kept effective. In this case, there is a problem in that cancellation of the assignment of the global IP address to the client PC by the router disconnects the session between the client PC and the server, thereby preventing communication between the client PC and the server.

### SUMMARY OF INVENTION

Therefore, it is an object of the present invention to provide an interconnecting device, an address conversion controlling method and a computer program thereof, which are capable of overcoming the above drawbacks accompanying the art. The above and other objects can be achieved by combinations described in the independent claims. The dependent claims define further advantageous and exemplary combinations of the present invention.

According to a first aspect of the present invention, an interconnecting device for interconnecting communication between a first communication device and a second communication device, comprises: a converter operable to convert a source address of a packet received from the first communication device from a first address, that is an address of the first communication device, to a second address, that is an address managed by the interconnecting device; a memory unit operable to store the first address and the second address in such a manner that the first address and the second address are registered to correspond to each other; a processing unit operable to determine whether or not a session between the first communication device and the second communication device has finished by transmitting a check packet, for confirming a communication status between the first communication device and the second communication device, to at least one of the first communication device and the second communication device; and a release unit operable to delete the corresponding registration of the first address and the second address in the memory unit, in a case where it was determined that the session between the first communication device and the second communication device had finished, to release the second address.

The first address may include a private IP address while the second address includes a global IP address, and the converter may have NAT function that assigns a global IP address to a private IP address.

The first address may include a private IP address and port number while the second address includes a global IP address and port number, and the converter may have IP masquerading function that assigns a global IP address and port number to a private IP address and port number.

The processing unit may transmit the check packet to the first communication device and the second communication device, and may determine whether or not the session between the first communication device and the second communication device has finished based on whether or not a response packet responding to the check packet was received from each of the first communication device and the second communication device.

The processing unit may transmit the check packet to the first communication device and the second communication device at a predetermined interval.

The processing unit may transmit the check packet to the first communication device after setting a source IP address of the check packet to an IP address of the second communication device.

The processing unit may transmit the check packet to the second communication device after setting a source IP address of the check packet to an IP address managed by the interconnecting device.

The processing unit may transmit the check packet to the first communication device and determine whether or not the first communication device finished the session with the second communication device based on whether or not a response packet responding to the check packet was received from the first communication device.

The processing unit may transmit the check packet to the second communication device in a case where the processing unit determined that the first communication device had not finished the session with the second communication device, and may determine whether or not the second communication device has finished the session with the first communication device based on whether or not the response packet responding to the check packet was received from the second communication device.

The processing unit may transmit the check packet to the first communication device at a first interval, determine whether or not the first communication device has finished the session with the second communication device based on whether or not the response packet responding to the check packet was received from the first communication device, transmit the check packet to the second communication device at a second interval, and determine whether or not the second communication device has finished the session with the first communication device based on whether or not the response packet responding to the check packet was received from the second communication device.

The first interval may be shorter than the second interval.

The interconnecting device may further comprise an interval determining unit operable to determine an interval at which the processing unit determines whether or not the session between the first communication device and the second communication device has finished, based on a type of the packet received from the first communication device.

The interval determining unit may determine the interval based on a destination port number of the packet received from the first communication device.

The interconnecting device may further comprise an interval determining unit operable to determine an interval at which the processing unit determines whether or not the session between the first communication device and the second communication device has finished, based on a number of the second address not assigned the corresponding first address.

According to a second aspect of the present invention, an address conversion controlling method for use in an interconnecting device for interconnecting communication between a first communication device and a second communication device, comprises the steps of: converting a source address of a packet received from the first communication device from a first address, that is an address of the first communication device, to a second address, that is an address managed by the interconnecting device; storing the first address and the second address in such a manner that the first address and the second address are registered to correspond to each other; determining whether or not a session between the first communication device and the second communication device has finished by transmitting a check packet, for confirming a communication status between the first communication device and the second communication device, to at least one of the first communication device and the second communication device; and deleting the corresponding registration of the first address and the second address stored in the storing step, in a case where it was determined that the session between the first communication device and the second communication device had finished, to release the second address.

The determination step may include transmitting the check packet to the first communication device and the second communication device; and determining whether or not the session between the first communication device and the second communication device has finished based on whether or not a response packet responding to the check packet was received from each of the first communication device and the second communication device.

The determination step may include transmitting the check packet to the first communication device; and determining whether or not the first communication device has finished the session with the second communication device based on whether or not a response packet responding to the check packet was received from the first communication device.

The determination step may further include transmitting the check packet to the second communication device in a case where the processing unit determined that the first communication device had not finished the session with the second communication device; and determining whether or not the second communication device has finished the session with the first communication device based on whether or not the response packet responding to the check packet was received from the second communication device.

The determination step may include transmitting the check packet to the first communication device at a first interval; determining whether or not the first communication device has finished the session with the second communication device based on whether or not the response packet responding to the check packet was received from the first communication device; transmitting the check packet to the second communication device at a second interval; and determining whether or not the second communication device has finished the session with the first communication device based on whether or not the response packet responding to the check packet was received from the second communication device.

According to a third aspect of the present invention, a computer program stored in a computer-readable medium for enabling an interconnecting device that interconnects communication between a first communication device and a second communication device, comprises: a converting module operable to instruct the interconnecting device to convert a source address of a packet received from the first communication device from a first address, that is an address of the first communication device, to a second address, that is an address managed by the interconnecting device; a storing module operable to instruct the interconnecting device to store the first address and the second address in such a manner that the first address and the second address are registered to correspond to each other; a processing module operable to instruct the interconnecting device to determine whether or not a session between the first communication device and the second communication device has finished by transmitting a check packet, for confirming a communication status between the first communication device and the second communication device, to at least one of the first communication device and the second communication device; and a release module operable to instruct the interconnecting device to delete the corresponding registration of the first address and the second address in the interconnecting device, in a case where it was determined that the session between the first communication device and the second communication device had finished, to release the second address.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 shows an exemplary structure of a computer network according to an embodiment of the present invention.

FIG. 2 shows an address converting table held by an interconnecting device according to the present embodiment of the invention.

FIG. 3 shows an exemplary structure of the interconnecting device according to the present embodiment of the invention.

FIG. 4 is a flowchart of an operation by the interconnecting device according to the present embodiment of the invention.

FIGS. 5A, 5B and 5C show intervals of transmission of a check packet by a processing unit of the interconnecting device according to the present embodiment of the invention.

FIG. 6 shows a hardware configuration of a PC according to the present embodiment of the invention.

### DETAILED DESCRIPTION

The invention will now be described based on preferred embodiments, which do not intend to limit the scope of the present invention, but exemplify the invention. All of the features and the combinations thereof described in the embodiments are not necessarily essential to the invention.

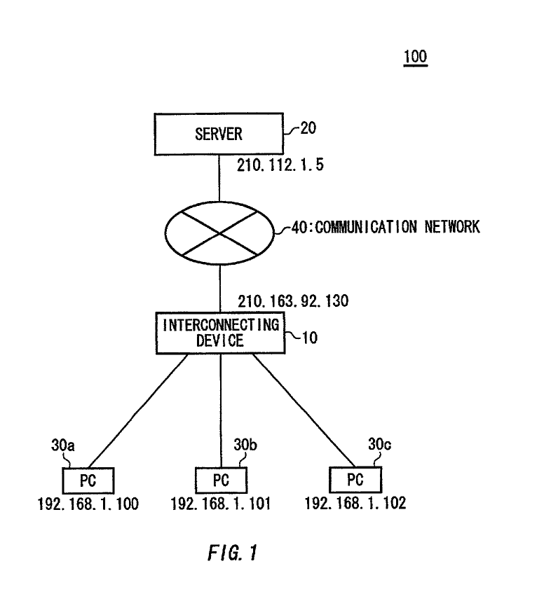

FIG. 1 illustrates an exemplary structure of a computer network 100 according to an embodiment of the present invention. The computer network 100 includes an interconnecting device 10, a server 20 and personal computers (PCs) 30a, 30b and 30c. The server 20 and the PCs 30a, 30b and 30c are exemplary communication devices. Although aspects of the present invention have been described with reference to PC 30a as an exemplary communication device, such reference is merely for convenience and does not limit the scope of the invention.

The interconnecting device 10 has IP masquerading function, which is an example of a NAT function, and interconnects communication by using a global IP address “210. 163. 92. 130”. An IP address of the server 20 is “210. 112. 1. 5”, while IP addresses of the PCs 30a, 30b and 30c are “192. 168. 1. 100”,“192. 168. 1. 101” and “192. 168. 1. 102”, respectively.

The server 20 may be a database server such as an FTP server or a management server. Moreover, the PCs 30a, 30b and 30c may download a file from the FTP server as the server 20 by using FTP, or may log in the management server as the server 20 via telnet to remotely control the server 20.

The interconnecting device 10 converts the source IP address of a packet received from any of the PCs 30a, 30b and 30c from the private IP address to the global IP address and then transmits the packet to a communication network 40, such as the Internet. The interconnecting device 10 converts the destination IP address of a packet received from the server 20 from the global IP address to the private IP address and then transmits the packet to the PC 30a, 30b or 30c. The interconnecting device 10 is, for example, a router.

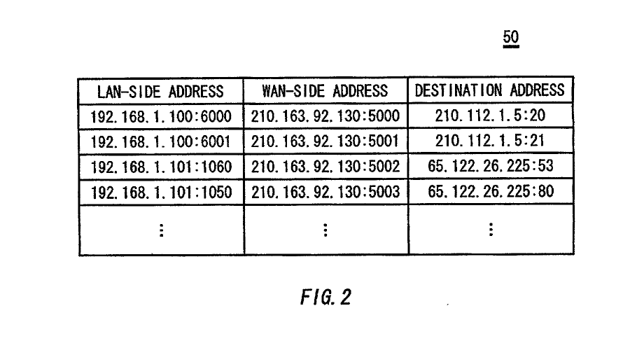

FIG. 2 shows an example of an address converting table 50 stored by the interconnecting device 10 according to the present embodiment. The address converting table 50 stores LAN-side addresses, WAN-side addresses and destination addresses so as to correspond to one another. The LAN-side address includes the private IP address and port number of the PC 30a, 30b or 30c, that is, the source IP address and port number of the packet the interconnecting device 10 receives from the PC 30a, 30b or 30c. The WAN-side addresses include the global IP addresses and port numbers managed by the interconnecting device 10, that is, the global IP addresses and port numbers assigned to the respective LAN-side addresses by the interconnecting device 10. The destination address includes the IP address and port number of the device with which the PC 30a, 30b or 30c communicates, that is, the destination IP address and the destination port number of the packet the interconnecting device 10 receives from the PC 30a, 30b or 30c.

The first row of the address converting table 50 is more specifically described. In the shown example, the address converting table 50 stores the IP address and port number of the PC 30a, “192. 168. 1. 100: 6000”, the global IP address and the port number managed by the interconnecting device 10, “210. 163. 92. 130: 5000”, and the IP address and the port number of the server 20, “210. 112.1. 5: 20” so as to correspond to one another.

Referring to FIGS. 1 and 2, an exemplary operation of the interconnecting device 10 in the communication between the PC 30a and the server 20 is described. When the interconnecting device 10 receives from the PC 30a a packet to be sent to the server 20, the interconnecting device 10 converts the private IP address, that is the source IP address, and the source port number of the received packet, “192. 168. 1. 100: 6000”, to the global IP address and port number, “210. 163. 92. 130: 5000” and then transmits the packet. The interconnecting device 10 also registers the private IP address and port number, “192. 168. 1. 100: 6000” and the global IP address and port number, “210. 163. 92. 130: 5000” in the address converting table 50 so as to correspond to each other.

Thereafter, the interconnecting device 10 interconnects the communication between the PC 30a and the server 20 by converting the source IP address and the source port number of the packet transmitted between the PC 30a and the server 20 from one of “192. 168. 1. 100: 6000” and “210. 163. 92. 130: 5000” to the other.

Moreover, the interconnecting device 10 transmits a check packet for confirming the status of the communication between the PC 30a and the server 20 to at least one of the PC 30a and the server 20, thereby determining whether or not the session between “192. 168. 1. 100: 6000” and “210. 112. 1. 5: 20” has finished. If the session between “192. 168. 1. 100: 6000” and “210. 112. 1. 5: 20” is determined to continue, the interconnecting device 10 keeps the corresponding registration of “192. 168. 1. 100: 6000” and “210. 112. 1. 5: 20” in the address converting table 50. If the session between “192. 168. 1. 100: 6000” and “210. 112. 1. 5: 20” does not continue, the corresponding registration of “192. 168. 1. 100: 6000” and “210. 112. 1. 5: 20” is deleted. The term “session” as used here is, for example, a TCP connection.

According to the interconnecting device 10 of the present embodiment, it is determined, before the corresponding registration in the address converting table 50 is deleted, whether or not the session between the PC 30a and the server 20 continues. Thus, even in a case where the PC 30a and the server 20 are in the waiting state, while the session between them is kept effective, but no packet is transmitted between them, the session between the PC 30a and the server 20 can be allowed to continue without deleting the corresponding registration in the address converting table 50.

In a case where the server 20 is an FTP server and the PC 30a downloads a file from the server 20 in accordance with FTP, for example, the PC 30a establishes two sessions, one being a control port for transferring commands between the PC 30a and the server 20 and the other being a data port for transferring the file. Thus, the interconnecting device 10 assigns, for example, “210. 163. 92. 130: 5001” to the control port “192. 168. 1. 100: 6001” and also assigns, for example, “210. 163. 92. 130: 5000” to the data port “192. 168. 1. 100: 6000”, so that the interconnecting device 10 registers these addresses and the port numbers in the address converting table 50. The interconnecting device 10 then interconnects the commands and the file transfer between the PC 30a and the server 20. In this case, when a file having a relatively large size is being transferred via the data port, communication is not performed between the PC 30a and the server 20 at the control port.

According to the interconnecting device 10 of the present embodiment, even in a case where a file having a relatively large size is transferred via the data port and a predetermined time has passed after the communication via the control port was performed, if the session continues at the control port, the corresponding registration in the address converting table 50 is not deleted. Therefore, it is possible to allow the session between the PC 30a and the server 20 at the control port to continue.

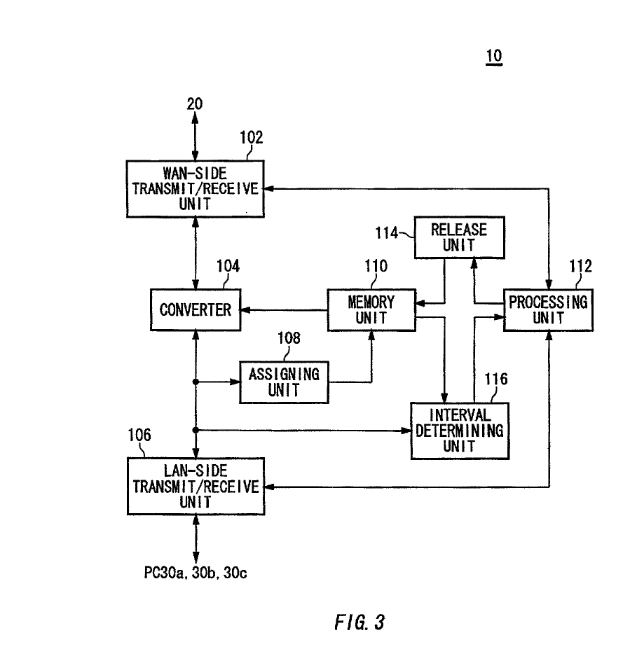

FIG. 3 shows an exemplary structure of the interconnecting device 10 according to the present invention. The interconnecting device 10 includes a WAN-side transmit/receive unit 102 that can be connected to the server 20 via the communication network 40, a LAN-side transmit/receive unit 106 that can be connected to the PCs 30a, 30b and 30c, a converter 104 operable to convert an IP address in a packet between the WAN-side transmit/receive unit 102 and the LAN-side transmit/receive unit 106, an assigning unit 108 operable to assign global IP addresses to the PCs 30a, 30b and 30c, respectively, a memory unit 110 operable to store the address converting table 50 shown in FIG. 2, a processing unit 1112 operable to determine whether or not a session between the PC 30a, 30b or 30c and the server 20 has finished, a release unit 114 operable to release the global IP address by deleting the corresponding registration related to the released global IP address in the address converting table, and an interval determining unit 116 operable to determine an interval of the determination by the processing unit 112 whether or not the session between the PC 30a, 30b or 30c and the server 20 finished.

The LAN-side transmit/receive unit 106 receives from the PC 30a, 30b or 30c the packet to be sent to the server 20. The converter 104 then refers to the address converting table 50 stored in the memory unit 110 so as to convert the source IP address and the source port number of the packet received by the LAN-side transmit/receive unit 106 from the private IP address and port number to the global IP address and port number. Then, the WAN-side transmit/receive unit 102 transmits the packet, having the global IP address and port number thus converted as the source IP address and the source port number, to the server 20.

In a case there is no global IP address and no port number in the address converting table 50 in the memory unit 110 for the source IP address and the source port number of the packet the LAN-side transmit/receive unit 106 receives from the PC 30a, the assigning unit 108 assigns a global IP address and a port number to the private IP address and port number of the PC 30a. The memory unit 110 then registers the private IP address and port number of the PC 30a and the global IP address and port number assigned by the assigning unit 108 in the address converting table 50 so as to correspond to each other. The converter 104 then refers to the address converting table 50 stored in the memory unit 110, thereby converting the source IP address and port number of the packet received by the LAN-side transmit/receive unit 106. In the present embodiment, the case where the assigning unit 108 has IP masquerading function is described. However, the assigning unit 108 may include a dynamic NAT function instead of IP masquerading function.

On the other hand, the WAN-side transmit/receive unit 102 receives from the server 20 the packet to be sent to the PC 30a, 30b or 30c. The converter 104 then refers to the address converting table 50 stored in the memory unit 110, thereby converting the destination IP address and port number of the packet received by the WAN-side transmit/receive unit 102. Then, the LAN-side transmit/receive unit 106 transmits the packet having the converted destination IP address and port number to the PC 30a, 30b or 30c.

The processing unit 112 determines whether or not a session between the PC 30a, 30b or 30c and the server 20, that corresponds to a corresponding registration in the address converting table 50, has finished. For example, in a case where “192. 168. 1. 100: 6000” and “210. 112. 1. 5: 20” are registered to correspond to each other, as shown in FIG. 2, the processing unit 112 determines whether or not the session between the port 6000 of the PC 30a and the port 20 of the server 20 had finished.

More specifically, in a case where the server 20 and the PC 30a establish the session by using a TCP connection, the processing unit 112 generates a check packet in which the source IP address is set to the IP address of the server 20, “210. 112. 1. 5”; the source port number is set to the port number of the server 20, “20”; the destination IP address is set to the IP address of the PC 30a, “192. 168. 1. 100”; and the destination port number is set to the port number of the PC 30a, “6000”. The generated check packet is transmitted to the PC 30a via the LAN-side transmit/receive unit 106. The processing unit 112 then determines whether or not the PC 30a finished the session with the server 20 based on whether or not a response packet responding to the transmitted check packet was received from the PC 30a.

Moreover, the processing unit 112 generates another check packet in which the source IP address is set to the IP address managed by the interconnecting device 10, “210. 163. 92. 130”; the source port number is set to the port number managed by the interconnecting device 10, “5000”; the destination IP address is set to the IP address of the server 20, “210. 112. 1. 5”; and the destination port number is set to the port number of the server 20, “20”. The generated check packet is transmitted to the server 20 via the WAN-side transmit/receive unit 102. The processing unit 112 then determines whether or not the server 20 finished the session with the PC 30a based on whether or not the response packet responding to the transmitted check packet was received from the server 20.

The processing unit 112 may transmit check packets both to the server 20 and the PC 30a, for example, at a predetermined interval, so as to determine whether or not the session between the server 20 and the PC 30a has finished based on whether or not the response packet responding to the corresponding check packet was received from each of the server 20 and the PC 30a. Moreover, the processing unit 112 may transmit the check packet to the PC 30a, for example, at a predetermined interval, and may transmit the check packet to the server 20 in a case where the response packet was received from the PC 30a. In this case, the processing unit 112 determines, based on whether or not the response packet responding to the check packet was received from the server 20, whether or not the session between the server 20 and the PC 30a has finished.

Furthermore, the processing unit 112 may transmit at a first interval the check packet to the PC 30a; determine whether or not the PC 30a has finished the session with the server 20 based on whether or not the response packet responding to the transmitted check packet was received from the PC 30a; transmit the check packet to the server 20 at a second interval; and determine whether or not the server 20 has finished the session with the 30a based on whether or not the response packet responding to the check packet was received from the server 20. In this case, it is preferable that the first interval be shorter than the second interval, because the possibility that the server 20 is inoperative due to some trouble is lower than the possibility that the PC 30a is inoperative.

The interval determining unit 116 may determine the interval at which the processing unit 112 determines whether or not the session between the PC 30a, 30b or 30c and the server 20 has finished, based on the type of the packet transmitted between the PC 30a, 30b or 30c and the server 20. For example, the interval determining unit 116 may determine the interval of the determination by the processing unit 112 whether or not the session between the PC 30a, 30b or 30c and the server 20 has finished, based on the destination port number of the packet received from the PC 30a, 30b or 30c by the LAN-side transmit/receive unit 106. specifically, in a case where the destination port number of the packet is “21”, the interval determining unit 116 can determine that the packet transfers the command in FTP. Thus, the interval determining unit 116 can set a longer interval of determination whether or not the session for transferring the packet has finished. In another case where the destination port number of the packet is “20”, the interval determining unit 116 can determine that the packet transfers data in accordance with FTP. Thus, the interval determining unit 116 can set a shorter interval of the determination whether or not the session for transferring that packet has finished.

The interval determining unit 116 may refer to the address converting table 50 and determine the interval of the determination by the processing unit 112 whether or not the session between the PC 30a, 30b or 30c and the server 20 has finished. The determination of the interval of determination may be based on the number of WAN-side addresses in the WAN-side address column of the address converting table 50 that are not assigned a corresponding LAN-side address.

The release unit 114 deletes the corresponding registration in the address converting table 50 when the processing unit 112 has determined that the session between the PC 30a, 30b or 30c and the server 20 had finished, which session corresponds to the corresponding registration in the address converting table 50, thereby releasing the global IP address and port number.

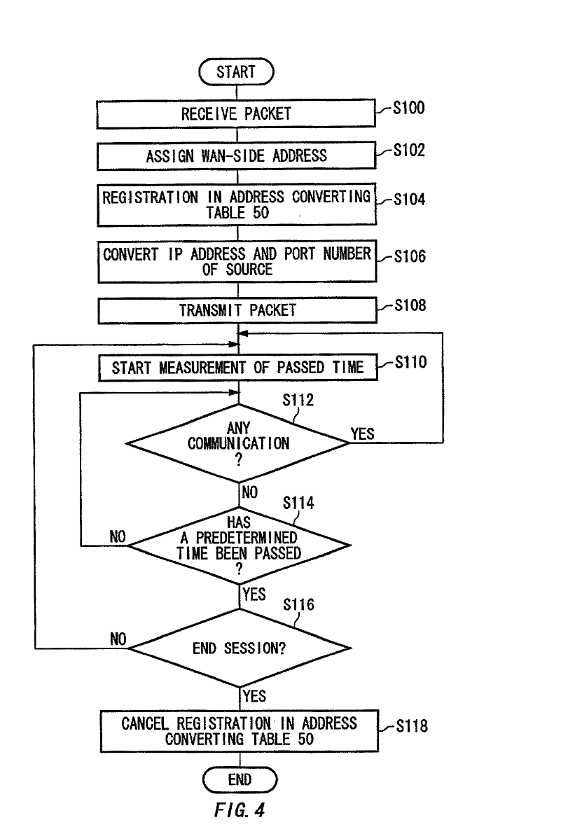

FIG. 4 is a flowchart of the operation of the interconnecting device 10 according to the present embodiment. First, the LAN-side transmit/receive unit 106 receives from the PC 30a the packet to be sent to the server 20 (Step S100). The assigning unit 108 then assigns the global IP address and port number to the source IP address and port number of the packet (Step S102). The memory unit 110 registers the private IP address of the PC 30a, that is the source IP address of the packet, and the source port number and the global IP address and port number assigned by the assigning unit 108 in the address converting table 50 in such a manner that the private IP address and port number correspond to the assigned global IP address and port number (Step S104).

The converter 104 refers to the address converting table 50 so as to convert the source IP address and port number of the packet (Step S106). Then, the WAN-side transmit/receive unit 102 transmits the packet having the source IP address and port number that were converted to the server 20 (Step S108). The processing unit 112 then starts to measure a time that has passed after the communication between the server 20 and the PC 30a was performed (Step S110).

The processing unit 112 always determines whether or not the server 20 and the PC 30a communicate with each other (Step S112). In a case where the processing unit 112 determines the server 20 and the PC 30a communicate with each other, the processing unit 112 measures again the time after the communication between the server 20 and the PC 30a was performed (Step S110). In another case where the processing unit 112 determines that there is no communication between the server 20 and the PC 30a, the processing unit 112 determines whether or not a predetermined time has passed after the last communication between the server 20 and the PC 30a (Step S114).

When determining in Step S114 that the predetermined time has not passed, the processing unit 112 continues to perform the determination whether or not the server 20 and the PC 30a communicate with each other (Step S112). The processing unit 112 determines whether or not the session between the server 20 and the PC 30a has finished when it is determined in Step S114 that the predetermined time has passed (Step S116).

The processing unit 112 measures again the time that has passed after the communication between the server 20 and the PC 30a was performed (Step S110), in a case where it is determined in Step S116 that the session has not finished. In a case where the processing unit 112 determines that the session has finished (Step S116), the release unit 114 deletes the corresponding registration of the private IP address and port number and the global IP address and port number of the PC 30a in the address converting table 50, thereby releasing the global IP address and port number (Step S118). Then, the operation flow is finished.

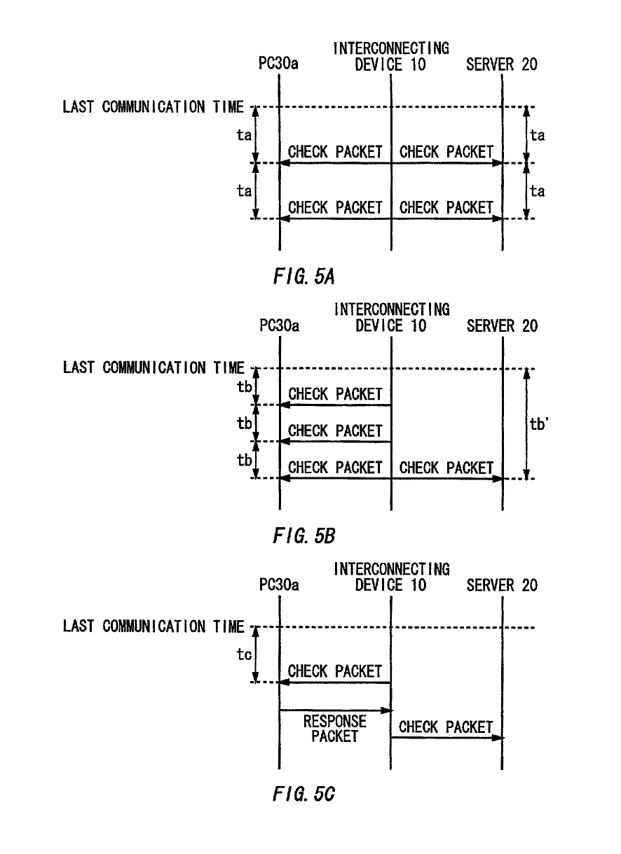

FIGS. 5A, 5B and 5C show exemplary intervals of the transmission of the check packet by the processing unit 112 according to the present embodiment. As shown in FIG. 5A, the processing unit 112 transmits the check packets both to the server 20 and the PC 30a when a predetermined time ta has passed after the last communication time, that is the last time at which the server 20 and the PC 30a communicated. In a case where the processing unit 112 receives the response packets responding to the check packets from both the server 20 and the PC 30a, the processing unit 112 then transmits again the check packets both to the server 20 and the PC 30a when the predetermined time ta has further passed. In a case where the processing unit 112 does not receive the response packet responding to the check packet from at least one of the server 20 and the PC 30a, the processing unit 112 determines that the session between the server 20 and the PC 30a has finished.

In the example shown in FIG. 5B, the processing unit 112 transmits the check packet to the PC 30a when a predetermined time tb has passed after the last communication time. In a case where the processing unit 112 receives the response packet responding to the check packet from the PC 30a, the processing unit 112 transmits again the check packet to the PC 30a when the predetermined time tb has further passed. The processing unit 112 also transmits the check packet to the server 20 when a predetermined time tb has passed after the last communication time. In a case where the processing unit 112 receives the response packet responding to the check packet from the server 20, the processing unit 112 transmits again the check packet to the server 20 when the predetermined time tb has further passed. According to the processing unit 112 of this example, it is possible to transmit the check packet to the server 20 at a longer interval. Thus, the amount of communication by the server 20 related to the transmission of the check packet can be reduced.

In the example shown in FIG. 5C, the processing unit 112 transmits the check packet to the PC 30a when a predetermined time tc has passed after the last communication time. In a case where the processing unit 112 receives the response packet responding to the check packet from the PC 30a, the processing unit 112 transmits the check packet to the server 20. According to the processing unit 112 of this example, the amount of communication by the server 20 related to the transmission of the check packet can be reduced because the processing unit 112 does not transmit the check packet to the server 20 in a case where the PC 30a has finished the session with the server 20.

According to the interconnecting device 10 of the present embodiment, it is determined, before the corresponding registration in the address converting table 50 is deleted, whether or not the session between the two communication devices related to that corresponding registration has finished. Thus, it is possible to prevent unexpected disconnection of the session. Moreover, by shortening the interval of the determination whether or not the session has finished, the global IP address and port number assigned to the finished session can be timely released. Thus, address resources can be used efficiently.

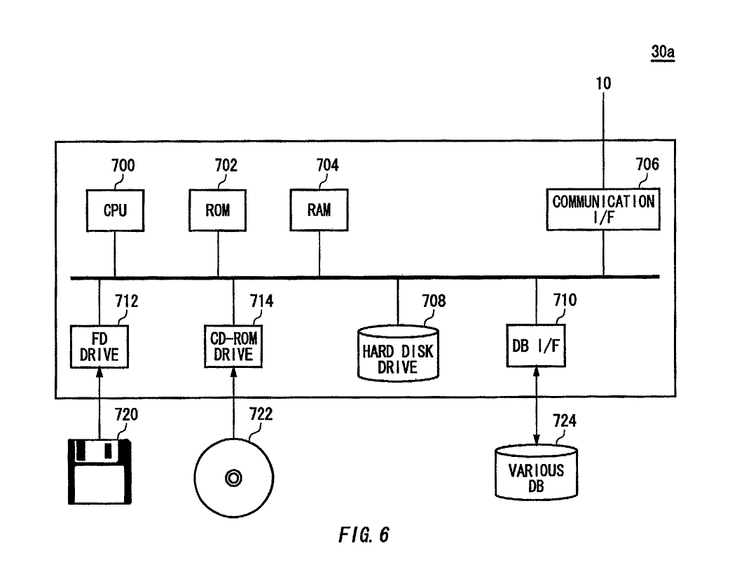

FIG. 6 illustrates an exemplary hardware configuration of the PC 30a according to the present embodiment. The PC 30a includes a CPU 700, a ROM 702, a RAM 704, a communication interface 706, a hard disk drive 708, a database interface 710, a floppy disk drive 712 and a CD-ROM drive 714. The CPU 700 operates based on at least one program stored in the ROM 702 and RAM 704 and controls the respective components of the PC 30a. The communication interface 706 communicates with the interconnecting device 10 through the computer network. The database interface 710 writes data into a database and updates the contents of the database.

The floppy disk drive 712 reads data or program from a floppy disk 720 to provide the read data or program to the communication interface 706. The CD-ROM drive 714 reads data or program from a CD-ROM 722 to provide the read data or program to the communication interface 706. The communication interface 706 transmits the data or program provided by the floppy disk drive 712 or CD-ROM drive 714 to the interconnecting device 10. The database interface 710 can be connected to various types of database 724 to perform data transmission and data receiving therewith.

The program provided to the interconnecting device 10 is provided by a user while being stored in a recording medium such as the floppy disk 720 or the CD-ROM 722. The program stored in the recording medium may be compressed or not-compressed. The program is read from the recording medium to be installed into the interconnecting device 10 via the communication interface 706, so that the interconnecting device 10 executes the program.

The program provided while being stored in the recording medium, that is the program to be installed into the interconnecting device 10, functionally includes a LAN-side transmit/receive module, a WAN-side transmit/receive module, a converting module, an assigning module, a storing module, a release module, a interval determining module and a processing module. Operations that are to be executed by the interconnection device 10 in accordance with instructions of the respective modules are the same as the operations of the corresponding components of the interconnecting device 10 described referring to FIGS. 1-5c, and therefore the description thereof is omitted.

A part or all of the functions and operations of the interconnecting device 10 according to all the embodiments described in the present application can be stored in the floppy disk 720 or the CD-ROM 722, as examples of the recording medium shown in FIG. 6.

These programs may be read directly into the interconnecting device 10 from the recording medium so as to be executed, or be executed by the interconnecting device 10 after being installed into the interconnecting device 10. Moreover, the above-mentioned programs may be stored in a single recording medium or a plurality of recording media. Furthermore, the programs may be stored while being encoded, for example, by encryption or compression.

As the recording medium, other than the floppy disk and the CD-ROM, an optical recording medium such as a DVD or a PD, a magneto-optical recording medium such as an MD, a tape-like medium, a magnetic recording medium, or a semiconductor memory such as an IC card or a miniature card can be used. Moreover, a storage device such as a hard disk or a RAM provided in a server system connected to an exclusive communication network or the Internet may be used as the recording medium, so that the program can be provided to the interconnecting device 10 through a communication network.

As is apparent from the above, according to the present invention, an interconnecting device is provided, which can prevent unexpected disconnection of a communication session by a NAT function and can use address resources efficiently.

Although the present invention has been described by way of exemplary embodiments, it should be understood that those skilled in the art might make many changes and substitutions without departing from the spirit and the scope of the present invention which is defined only by the appended claims.

1. An interconnecting device that interconnects communication between a first communication device and a second communication device, comprising:
a converter operable to convert a source address of a packet received from said first communication device from a first address, that is an address of said first communication device, to a second address, that is an address managed by said interconnecting device;
a memory unit operable to store said first address and said second address in such a manner that said first address and said second address are registered to correspond to each other;
a processing unit operable to determine whether or not a session between said first communication device and said second communication device has finished by transmitting a check packet, for confirming a communication status between said first communication device and said second communication device, to at least one of said first communication device and said second communication device; and
a release unit operable to delete the corresponding registration of said first address and said second address in said memory unit, in a case where it was determined that said session between said first communication device and said second communication device had finished, to release said second address.

2. An interconnecting device as claimed in claim 1, where in said first address includes a private IP address while said second address includes a global IP address, and said converter has NAT functionality that assigns said global IP address to said private IP address.

3. An interconnecting device as claimed in claim 1, wherein said first address includes a private IP address and port number while said second address includes a global IP address and port number, and
said converter has IP masquerading functionality that assigns said global IP address and port number to said private IP address and port number.

4. An interconnecting device as claimed in claim 1, wherein said processing unit transmits said check packet to said first communication device and said second communication device, and determines whether or not said session between said first communication device and said second communication device has finished based on whether or not a response packet responding to said check packet was received from each of said first communication device and said second communication device.

5. An interconnecting device as claimed in claim 4, wherein said processing unit transmits said check packet to said first communication device and said second communication device at a predetermined interval.

6. An interconnecting device as claimed in claim 5, wherein said processing unit transmits said check packet to said first communication device after setting a source IP address of said check packet to an IP address of said second communication device.

7. An interconnecting device as claimed in claim 5, wherein said processing unit transmits said check packet to said second communication device after setting a source IP address of said check packet to an IP address managed by said interconnecting device.

8. An interconnecting device as claimed in claim 1, wherein said processing unit transmits said check packet to said first communication device and determines whether or not said first communication device finished said session with said second communication device based on whether or not a response packet responding to said check packet was received from said first communication device.

9. An interconnecting device as claimed in claim 8, wherein said processing unit transmits said check packet to said second communication device in a case where said processing unit determines that said first communication device had not finished said session with said second communication device, and determines whether or not said second communication device has finished said session with said first communication device based on whether or not said response packet responding to said check packet was received from said second communication device.

10. An interconnecting device as claimed in claim 8, wherein said processing unit transmits said check packet to said first communication device at a first interval, determines whether or not said first communication device has finished said session with said second communication device based on whether or not said response packet responding to said check packet was received from said first communication device, transmits said check packet to said second communication device at a second interval, and determines whether or not said second communication device has finished said session with said first communication device based on whether or not said response packet responding to said check packet was received from said second communication device.

11. An interconnecting device as claimed in claim 10, wherein said first interval is shorter than said second interval.

12. An inter connecting device as claimed in claim 1, further comprising an interval determining unit operable to determine an interval at which said processing unit determines whether or not said session between said first communication device and said second communication device has finished, based on a type of said packet received from said first communication device.

13. An interconnecting device as claimed in claim 12, wherein said interval determining unit determines said interval based on a destination port number said packet received from said first communication device.

14. An interconnecting device as claimed in claim 1, further comprising an interval determining unit operable to determine an interval at which said processing unit determines whether or not said session between said first communication device and said second communication device has finished, based on a number of said second address not assigned said corresponding first address.

15. An address conversion controlling method for use in an interconnecting device that interconnects communication between a first communication device and a second communication device, said method comprising:
converting a source address of a packet received from said first communication device from a first address, that is an address of said first communication device, to a second address, that is an address managed by said interconnecting device;
storing said first address and said second address in such a manner that said first address and said second address are registered to correspond to each other;
determining whether or not a session between said first communication device and said second communication device has finished by transmitting a check packet, for confirming a communication status between said first communication device and said second communication device, to at least one of said first communication device and said second communication device; and
deleting the corresponding registration of said first address and said second address, in a case where it was determined that said session between said first communication device and said second communication device had finished, to release said second address.

16. An address conversion controlling method as claimed in claim 15, wherein said determination step includes:
transmitting said check packet to said first communication device and said second communication device; and
determining whether or not said session between said first communication device and said second communication device has finished based on whether or not a response packet responding to said check packet was received from each of said first communication device and said second communication device.

17. An address conversion controlling method as claimed in claim 15, wherein said determination step includes:
transmitting said check packet to said first communication device; and
determining whether or not said first communication device has finished said session with said second communication device based on whether or not a response packet responding to said check packet was received from said first communication device.

18. An address conversion controlling method as claimed in claim 17, wherein said determination step further includes:
transmitting said check packet to said second communication device in a case where said processing unit determines that said first communication device had not finished said session with said second communication device; and
determining whether or not said second communication device has finished said session with said first communication device based on whether or not said response packet responding to said check packet was received from said second communication device.

19. An address conversion controlling method as claimed in claim 17, wherein said determination step further includes:
transmitting said check packet to said first communication device at a first interval;
determining whether or not said first communication device has finished said session with said second communication device based on whether or not said response packet responding to said check packet was received from said first communication device;
transmitting said check packet to said second communication device at a second interval; and
determining whether or not said second communication device has finished said session with said first communication device based on whether or not said response packet responding to said check packet was received from said second communication device.

20. A program, stored in a computer readable medium, for use with an interconnecting device that interconnects communication between a first communication device and a second communication device, said program comprising:
a converting module operable to instruct said interconnecting device to convert a source address of a packet received from said first communication device from a first address, that is an address of said first communication device, to a second address, that is an address managed by said interconnecting device;
a storing module operable to instruct said interconnecting device to store said first address and said second address in such a manner that said first address and said second address are registered to correspond to each other;
a processing module operable to instruct said interconnecting device to determine whether or not a session between said first communication device and said second communication device has finished by transmitting a check packet, for confirming a communication status between said first communication device and said second communication device, to at least one of said first communication device and said second communication device; and
a release module operable to instruct said interconnecting device to delete the corresponding registration of said first address and said second address in said interconnecting device, in a case where it was determined that said session between said first communication device and said second communication device had finished, to release said second address.
